(19) United States
(12) Patent Application Publication
(10) Pub. No.: US 2008/0130628 A1
(43) Pub. Date: Jun. 5, 2008

(54) SYSTEMS AND METHODS FOR PROVIDING ADVANCED CALL PROCESSING FEATURES TO ANALOG TELEPHONE SUBSCRIBERS

(76) Inventors: Shiejye Geoffrey Lin, Duluth, GA (US); Karen McCourt, Alpharetta, GA (US)

Correspondence Address: MYERS BIGEL SIBLEY & SAJOVEC, P.A., P.O. BOX 37428, RALEIGH, NC, 27627, US

(21) Appl. No.: 11/557,233

(22) Filed: Nov. 7, 2006

(51) Int. Cl. H04L 12/66

(52) U.S. Cl. 370/352; 379/211.02

(57) ABSTRACT

Methods of obtaining call processing instructions for a call to or from an analog telephone in a switched telephone network are disclosed. The methods include receiving a notification of the call at a service switching point (SSP) that serves the analog telephone, and sending a call processing instruction request to a network element that is also coupled to a data communication network. The methods further include translating the call processing instruction request to a translated request having a format suitable for transmission over the data communication network, and sending the translated request to a feature server over the data communication network. The translated request is analyzed to determine a call processing disposition for the call, and a response is sent to the network element over the data communication network identifying the determined call processing disposition for the call. The response is translated into a format suitable for transmission to the SSP, and the translated response is sent to the SSP. The call is processed based on the translated response.

### FIELD OF THE INVENTION

The present invention relates to methods and systems for handling telephone calls to/from telephone sets. In particular, the present invention relates to methods and systems for providing VoIP-like advanced calling features to existing customer premises equipment.

### BACKGROUND

VoIP systems provide users with certain functionality not typically available to users of traditional analog telephone services. For example, a user of a VoIP system may be able to customize incoming and outgoing call handling procedures, call preferences, call permissions, etc., using an IP interface to a feature server (application server). Call notifications may be provided to a user via instant messaging, and a user may be able to adjust call handling for an incoming call via an IP connection with the feature server without answering the call.

Internet telephony, also referred to herein as Voice-Over Internet Protocol (VoIP), Voice-Over Network (VON), and/or Internet Protocol Telephony (IP Telephony), is becoming increasing popular due, in part, to marked improvements in reliability and sound quality of the service. The improved performance of Internet telephony communications may be due, in large part, to upgrading the internet backbone with improved switching fabrics, such as Asynchronous Transfer Mode (ATM) and to implementation of new communications standards, such as standards for transport protocols, directory services, and/or audio codec format.

Currently, to provide Internet telephony communications to a subscriber, a subscriber must obtain equipment, such as Integrated Access Devices (IADs), Analog Terminal Adaptors (ATAs), telephone adapters (TAs) and the like, to be installed at the subscriber's premises, for example, a customer's home. The equipment is needed to support a voice path within the premises and through the broadband connection, for example, a digital subscriber line (DSL) connection, back to the Internet Service Provider (ISP). Once the necessary equipment is installed, customers/subscribers can connect their existing analog phones, for example, Plain Old Telephone Service (POTS) phones, to the Analog Terminal Adaptors (ATAs) or telephone adapters (TAs) to originate and/or receive calls using Internet telephony, for example, over a VoIP line. A VoIP dial-tone is provided by the telephone adaptor (TA) to any phone extensions with ATAs connected.

Although, the idea of Internet Telephony may be attractive to customers because of the enhanced features and services associated with VoIP, some customers may not be willing to purchase and/or install the required equipment necessary to enable use of Internet telephony services. Furthermore, although customers are used to Internet power outages that may cause them to be unable to access their email on the world wide web (www), customers may not be willing to accept these types of Internet or power outages and unpredictability of these outages when it comes to VoIP service, i.e., their telephone service.

Similarly, Internet Service Providers (ISPs), i.e., providers of data communications network services, typically like to avoid professional installation of equipment to minimize their payback period and increase their return-on-investment. Furthermore, local exchange carriers, for example, telephone service providers, typically want to exploit as much of the existing operations, administration, management, and provisioning (OAM&P) solutions that they have in place today for VoIP lines, so as to allow the local exchange carriers to increase efficiency of the existing telecommunications network. Use of existing OAM&P may decrease the amount of necessary training and capital expenses.

Some advanced calling features, such as call forwarding, are provided by Advanced Intelligent Network (AIN) functionality that is included in some current telephone systems. However, the increased functionality provided by AIN may not be as extensive or user-configurable as VoIP services can be. Some attempts have been made to provide VoIP-like services and features to existing analog telephones. However, such attempts have been limited due to the need for proprietary signaling protocols and/or extra telephone network resources. For example, an AIN switch may be configured to forward a call to/from a PSTN subscriber terminal served by the AIN switch to an IP server that can manage call setup for the call. However, such an approach may require additional phone numbers and/or PSTN trunk port resources.

### SUMMARY

Some embodiments of the invention provide methods of obtaining call processing instructions for a call to or from an analog telephone in a switched telephone network. The methods include receiving a notification of the call at a service switching point that serves the analog telephone, and sending a call processing instruction request to a network element in the switched telephone network that is also coupled to a data communication network. The call processing instruction request may include at least an identity of the calling party and an identity of the called party. The methods further include translating the call processing instruction request to a translated request having a format suitable for transmission over the data communication network, and sending the translated request to a feature server over the data communication network. The translated request is analyzed at the feature server to determine a call processing disposition for the call, and a response is sent from the feature server to the network element over the data communication network identifying the determined call processing disposition for the call.

The methods may further include translating the response from the feature server into a translated response suitable for sending on a switching control network in the switched telephone network, sending the translated response to the service switching point, and processing the call at the service switching point in response to the translated response.

The switching control network may include an SS7 switching network, and the call processing instruction request may include a Transaction Capabilities Access Part (TCAP) message.

The data communications network may include an IP network, and translating the call processing instruction request may include translating the call processing instruction request from a TCAP message to a Session Initiation Protocol (SIP) message.

The response from the feature server may include a SIP message. In particular, the translated request may include a SIP-INVITE message and the response from the feature server may include a SIP-INVITE message (as the feature server may be configured to act as a back-to-back user agent). The call processing instruction request may include a TCAP(Termination_attempt) message or a TCAP(Info_analyze) message. The translated response sent to the service switching point may include a TCAP(Forward_call), a TCAP(Authorize_termination), a TCAP(Disconnect), or a TCAP(Analyze_route) message.

The service switching point may include an advanced intelligent network (AIN) switch that is configured to send and receive TCAP messages. The methods may further include activating an AIN trigger in response to receiving the notification of the call at the service switching point. The AIN trigger may indicate that an alternate call processing routine is to be followed for the call.

The methods may further include receiving the translated request at the feature server over the data communication network, analyzing the translated request to determine an identity of a subscriber associated with the call identified in the translated request, and retrieving a profile associated with the subscriber from a profile database.

The methods may further include sending a notification message over the data communication network to a subscriber terminal associated with the determined subscriber identity. The notification message may request instructions for processing the call identified in the translated request.

The methods may further include receiving a response to the notification message from the subscriber terminal over the data communication network, and preparing the response from the feature server based on the response from the subscriber terminal.

Methods of obtaining call processing instructions for a call to or from an analog telephone in a switched telephone network according to further embodiments of the invention include receiving a notification of the call at a service switching point that serves the analog telephone, and sending a call processing instruction request to a network element in the switched telephone network that is also coupled to a data communication network. The call processing instruction request includes at least an identity of the calling party and an identity of the called party. The methods further include analyzing the call processing instruction request to determine an identity of a subscriber associated with the call identified in the translated message, retrieving a profile associated with the subscriber from a profile database, and sending a notification message over the data communication network to a subscriber terminal associated with the determined subscriber identity. The notification message may request instructions for processing the call identified in the call processing instruction request.

The methods may further include receiving a response to the notification message from the subscriber terminal over the data communication network, and preparing a response to the call processing instruction request based on the response from the subscriber terminal.

The methods may further include sending the response to the call processing instruction request to the service switching point over a switching control network in the switched telephone network, and processing the call at the service switching point based on the response.

The switching control network may include an SS7 switching network, and the call processing instruction request and the response to the call processing instruction request include Transaction Capabilities Access Part (TCAP) messages. In particular, the call processing instruction request may include a TCAP(Termination_attempt) message or a TCAP(Info_analyze) message, while the response to the call processing instruction request may include a TCAP(Forward_call), a TCAP(Authorize_termination), a TCAP(Disconnect), or a TCAP(Analyze_route) message. The service switching point may include an advanced intelligent network (AIN) switch that is configured to send and receive TCAP messages.

A communication system according to some embodiments of the invention includes a service switching point that serves an analog telephone in a switched telephone network and that is configured to receive a notification of an incoming or outgoing call for the analog telephone and to send a call processing instruction request identifying including at least an identity of the calling party and an identity of the called party in response to the incoming or outgoing call notification. The system further includes an IP switch that is coupled to the switched telephone network and that is configured to receive the call processing instruction request and to translate the call processing instruction request to provide a translated request. The system further includes a feature server that is connected to a data communication network and that is configured to receive the translated request from the IP switch, to analyze the translated request to determine a call processing disposition for the call according to a user profile that may be configurable by a user of the analog telephone via the data communication network, and to send a response to the IP switch identifying the determined call processing disposition for the call.

The IP switch may be further configured to translate the response received from the feature server into a translated response suitable for sending on a switching control network in the switched telephone network, and to send the translated response to the service switching point. The service switching point may be configured to process the call based on the translated response.

The switching control network may include an SS7 switching network, and the call processing instruction request may include a Transaction Capabilities Access Part (TCAP) message.

The data communication network may include an IP network, and the IP switch may be configured to translate the call processing instruction request from a TCAP message to a SIP message and to send the translated request to the feature server via the data communication network.

The feature server may be further configured to analyze the translated message to determine an identity of a subscriber associated with the call identified in the translated message, and to retrieve a profile associated with the subscriber from a profile database. In addition, the feature server may be configured to send a notification message over the data communication network to a subscriber terminal associated with the determined subscriber identity, the notification message requesting instructions for processing the call identified in the call processing instruction request, to receive a response to the notification message from the subscriber terminal over the data communication network, and to prepare the response to the call processing instruction request based on the response from the subscriber terminal.

The feature server may include a feature server module in the IP switch.

It will be understood that the present invention may also be embodied as computer program products. Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagram illustrating systems and/or methods according to embodiments of the invention.

FIGS. 2 and 3 are diagrams illustrating operations and/or message flows according to some embodiments of the invention.

FIG. 4 is a schematic block diagram illustrating systems and/or methods according to further embodiments of the invention.

### DETAILED DESCRIPTION OF EMBODIMENTS OF THE INVENTION

Some embodiments of the invention provide telecommunication systems and methods with improved call handling capabilities. In particular, some embodiments of the invention provide VoIP-like services to conventional analog telephone sets without requiring installation of additional customer premises equipment. Furthermore, VoIP-like services may be provided according to some embodiments of the invention while routing calls through conventional switched telephone networks.

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer usable program code embodied in the medium. Any suitable computer readable medium may be utilized including hard disks, CD ROMs, optical storage devices, a transmission media such as those supporting the Internet or an intranet, or magnetic storage devices.

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

As discussed in the background, in order to provide Internet telephony services to a customer, equipment, such as Integrated Access Devices (TADs), Analog Terminal Adaptors (ATAs), telephone adapters (TAs) and the like may be installed at the customer's premises. The purchase and installation of such equipment may not be desirable for any of the parties involved. Embodiments of the present invention provide Voice Over IP (VoIP)-like services and/or functionality that does not require additional customer premises equipment (CPE), such as home gateways, analog telephone adaptors (ATAs) and the like. In particular, some embodiments of the invention may route call setup and handling signals via a communications network to a user-configurable feature server that participates in call setup and handling, thereby providing features and services similar to VoIP services to standard customer premises equipment without the need for additional hardware and/or without the need to route calls through data networks.

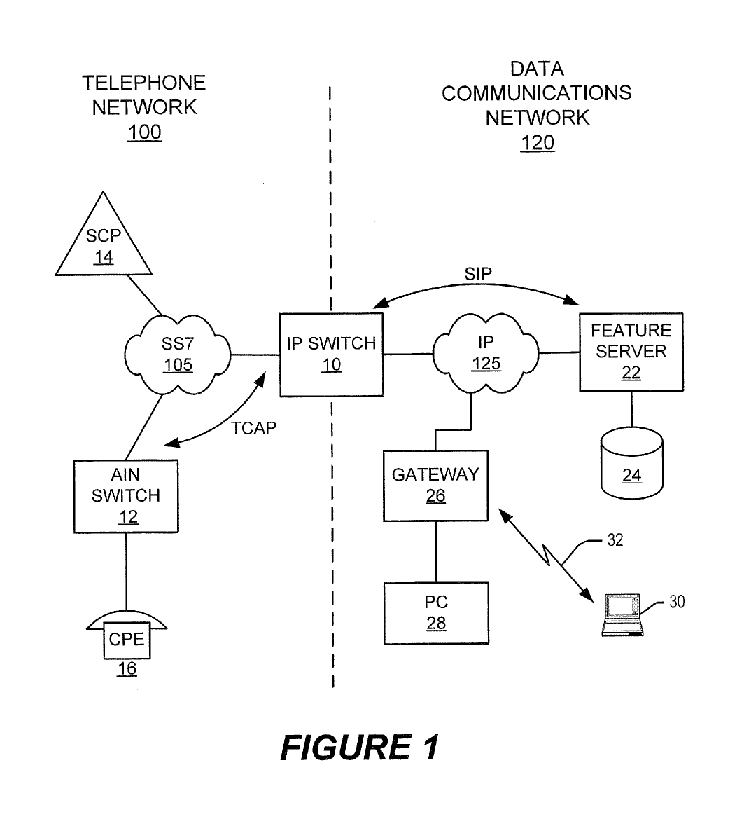

FIG. 1 illustrates a hybrid communication system including a switched telephone network 100 including, for example, an SS7 signaling network backbone 105, and a data communications network 120 including, for example, an internet protocol (IP) based data communications network backbone 125. It will be appreciated that the switched telephone network 100 may be a public switched telephone network (PSTN) as is conventionally used to provide switched telephone services to subscribers in a given geographic area. The data communications network 120 may be any data communications network, including proprietary and/or non-proprietary networks. Furthermore, the data communications network may use proprietary and/or non-proprietary data communications protocols. In particular embodiments, however, the data communications network may include the Internet, and data communications may be performed using internet protocol (IP).

The telephone network 100 includes a service control point 14 that is generally responsible for coordinating call setup and management for telephone calls made to/from terminals in the network 100, such as customer premises equipment (CPE) 16. The CPE 16 may include, for example, a conventional analog telephone located at a subscriber's home and/or office. The CPE 16 is connected to the telephone network 100 through a service switching point, such as the Advanced Intelligent Network (AIN) switch 12 shown in FIG. 1.

AIN is a subset of SS7 signaling protocols that was developed in order to provide advanced call handling capabilities to terminals in switched telephone networks. AIN processing provides a telephone network architecture and associated protocols by which network elements may communicate with the SCP 14 to coordinate call processing. In particular, an AIN-enabled switch, such as the AIN switch 12, may be configured to perform advanced call processing functions in conjunction with the SCP 14. The AIN switch 12 and the SCP 14 may coordinate call setup and processing by exchanging messages over the SS7 network 105 conforming to the Transaction Capabilities Access Part (TCAP) protocol, which is a subset of the SS7 protocol.

The SCP 14 maintains service provider instructions and data that direct switch processing and provide call control. When an incoming or outgoing call is received at the AIN switch 12, the AIN switch 12 may suspend call processing in response to a predefined AIN trigger and query the SCP 14 for instructions on further call processing. The query may include information concerning the call, such as the called party number, the calling party number, the current state of the call, etc. The SCP 14 analyzes the call information received from the AIN switch 12 and returns appropriate instructions to the AIN switch 12 via the SS7 signaling network 105. The AIN switch 12 then analyzes the information received from the SCP 14 and processes the call according to the instructions from the SCP 14.

AIN processing, such as that described above, may enable an operator of a switched telephone network to provide enhanced services to subscribers, including call forwarding, voicemail, disaster recovery, as well as other services. However, configuration of such services, and provision of additional services, such as VoIP-like services, may be difficult using AIN processing alone.

As further shown in FIG. 1, embodiments of the invention provide a soft switch/IP switch 10 configured to send/receive SS7 messages over the SS7 signaling network 105. In particular, the IP switch 10 may be configured to send/receive TCAP messages to/from the AIN switch 12.

As noted above, the AIN switch 12 communicates with the service control point (SCP) 14 in the telephone network 100. When an incoming call is received for a CPE 16 served by the AIN switch 12, the AIN switch 12 looks up the subscriber profile of the subscriber that is being called. In some embodiments, when a call is received for an identified subscriber, an AIN trigger occurs and call processing is interrupted while the AIN switch 12 sends a TCAP message to obtain call processing information for the call.

Processing by the AIN switch 12 is similar to conventional call handling protocols in which an AIN switch 12 interrupts call processing to send a TCAP message to the SCP 14 to obtain call processing instructions, to retrieve caller ID information, or for other purposes. According to some embodiments of the invention, for a particular subscriber that subscribes to advanced call handling services, instead of sending a query to the SCP 14, a TCAP message may be sent to the IP switch 10 via the SS7 signaling network 105. The IP switch 10 is configured to communicate both with elements of the telephone network 100 using the SS7 signaling network 105, and also to communicate with devices on a data communication network 120. For example, the IP switch 10 may also be configured to communicate with other terminals, for example over an IP based network 125 such as the Internet using the TCP/IP protocol and/or another public or private data communications network.

In particular, the IP switch 10 is configured to receive a TCAP message from the AIN switch 12 and to translate the TCAP message into one or more data communication messages that may be sent on the data communication network 120. In some embodiments, the IP switch 10 is configured to translate TCAP messages into SIP (Session Initiation Protocol) messages (and vice versa) that may be sent/received on an IP network 125. SIP is an application layer signaling protocol that may be used for VoIP applications. In particular, SIP is a peer-to-peer protocol developed for initiating, modifying, and terminating an interactive user session on an IP network. Devices connected to the IP network 125 may communicate directly with one another using SIP. However, other protocols, such as ITU recommendation H.323, may be used besides SIP for communication between the IP switch 10 and other IP network elements.

The SIP message(s) identify the subscriber (in this case the CPE 16) and may designate the type of connection requested (e.g. incoming call, outgoing call). In addition, the SIP message(s) may identify the external called/calling party and/or any other information desirable for controlling call handling for the subscriber.

The translated SIP message may be forwarded to a Feature Server 22 via an IP connection through the IP network 125. The Feature Server 22 is configured to manage the call setup and processing for a subscriber served by the AIN switch 12 in response to the translated or parsed TCAP message(s).

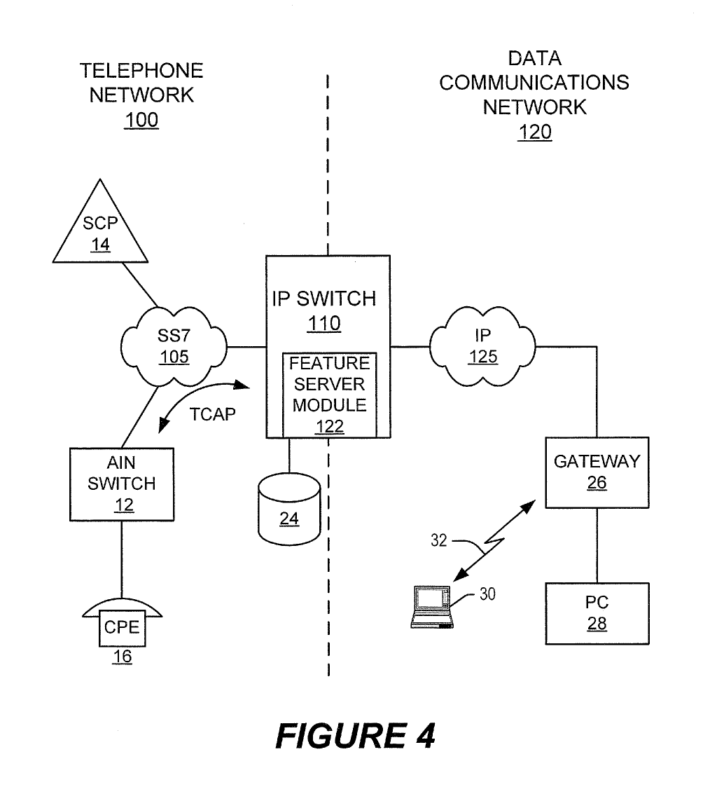

In some embodiments illustrated in FIG. 4, the functions of the Feature Server may be implemented as a Feature Server module 122 within an IP switch 110, in which case the TCAP message may be parsed and delivered directly to the Feature Server module 122 of the IP switch 10. Descriptions of the operation of a Feature Server 22 herein shall apply to the Feature Server module 122 illustrated in FIG. 4, except that SIP messages may not be exchanged between the Feature Server module 122 and the IP switch 110 in which the Feature Server module 122 is implemented.

Referring again to FIG. 1, upon receipt of the SIP message from the IP switch 10, the Feature Server 22 may examine the SIP message to determine the identity of the subscriber associated with the SIP message. The Feature Server 22 may retrieve a profile associated with the subscriber from a Profile Database 24, which may be located locally and/or remotely to the Feature Server 22. Call handling for the call identified in the SIP message may be determined based on the contents of the subscriber's profile. For example, a subscriber profile may indicate that calls to/from a particular number should be forwarded, terminated, transferred to voicemail, etc.

The IP Switch 10 may be a conventional IP switch such as an IP switch manufactured by Sonus Networks, Inc., having both PSTN and IP functionality. However, according to some embodiments of the invention, the IP switch 10 may be configured to receive TCAP messages, to establish a SIP session with the Feature Server 22, to translate the TCAP messages to SIP, and to forward the SIP messages to the Feature Server 22 via the established SIP session. The IP Switch 10 is also configured to receive SIP responses from the Feature Server 22 and to construct appropriate TCAP messages based on the SIP responses from the Feature Server 22 that instruct the AIN switch 12 to process the call as directed by the Feature Server 22.

Configuration of the IP Switch 10 may be performed, for example, by modifying the application software of the IP Switch 10 such that the IP switch 10 is configured to translate TCAP messages to SIP messages, and vice versa, as provided herein.

As noted above, the functionality of the Feature Server 22 could be implemented as a separate module in the IP Switch 22. However, keeping the Feature Server 22 and the IP Switch 10 separate may permit a system operator to take advantage of existing Feature Servers 22 with minimal reconfiguration of the IP Switch 10 required.

Outgoing call control may be handled similarly to incoming call handling. For example, when an outgoing call request from the subscriber terminal 16 is received at the AIN switch 12, the AIN switch 12 retrieves a subscriber profile associated with the subscriber terminal 15 and, in response to the subscriber profile, activates an AIN trigger (where previously the AIN switch 12 would simply notify the SCP 14 of the outgoing call request and obtain call routing instructions from the SCP 14). Call processing for the outgoing call is interrupted while the AIN switch 12 sends a TCAP message to the IP Switch 10. The IP Switch 10 translates the TCAP message to one or more SIP messages, and forwards the SIP message(s) to a local or remote Feature Server 22. The Feature Server 22 examines the SIP message to determine the identity of the subscriber terminal associated with the SIP message. The Feature Server 22 then looks up the subscriber profile associated with the subscriber terminal 16 and determines appropriate call handling protocols, which are communicated back to the IP Switch 10 via an SIP message transmitted over the IP network 125. The IP Switch 10 constructs an appropriate TCAP message containing call handling procedures specified in the SIP message, and forwards the TCAP message to the AIN switch 12 via the SS7 network 105. The AIN switch 12 then processes the call according to the instructions specified in the TCAP message from the IP switch 10.

User profile information at the Feature Server 22 may be accessed/modified by the user, for example, using an IP connection between a user terminal (PC) 28 and the Feature Server 22. As shown in FIG. 1, a subscriber IP terminal 28 may access the Feature Server 22 through a gateway 26 that connects the subscriber IP terminal 28 to the IP network 125. The subscriber IP terminal 28 may be any user terminal that is capable of establishing an HTTP connection with the Feature Server 22 using the IP network 125. For example, the user may also access the Feature Server 22 using a wireless terminal 30, which may be, for example, a laptop computer, a handheld computing device, a wireless telephone, or any other wireless device having a user interface and capable of establishing a connection with the Feature Server 22 over the IP network 125. In particular embodiments, the Feature Server 22 may provide a web-based user interface to a subscriber IP terminal 28, 30 that may permit a user of the subscriber IP terminal 28, 30 to establish and/or modify user profile information stored in the Feature Server 22 and/or the Profile Database 24.

In embodiments, such as the embodiments illustrated in FIG. 4, in which the Feature Server is implemented as a software Feature Server module 122 in an IP switch 110, the subscriber IP terminal 28, 30 may communicate with the Feature Server module 122 via an IP connection with the IP switch 10 through the IP network 125.

Accordingly, a user can dynamically modify call handling preferences and/or permissions stored in a user profile and used by the Feature Server 22 to respond to call handling queries, for example, using an internet connection and a standard internet browser software.

The Feature Server 22 may maintain and consult a presence indication for each subscriber to determine if the subscriber is online or offline when a SIP message relating to that subscriber is received. In addition to call handling, the Feature Server 22 may, upon receipt of the SIP message from the IP Switch 10, send a notification message, such as an instant message, email, or other notification to the subscriber, for example, over the IP network 125. The subscriber IP terminal 28, 30 may include application-specific client software configured to permit the user to respond to the notification message in order to dictate call handling procedures for the incoming call in real time. Alternatively, dynamic control of the incoming call may be accomplished using a conventional HTTP-based browser connected to the Feature Server 22 through the IP network 125. Thus, for example, the user could instruct the Feature Server 22 to terminate the call, transfer the call to another telephone number, transfer the call to voicemail, etc.

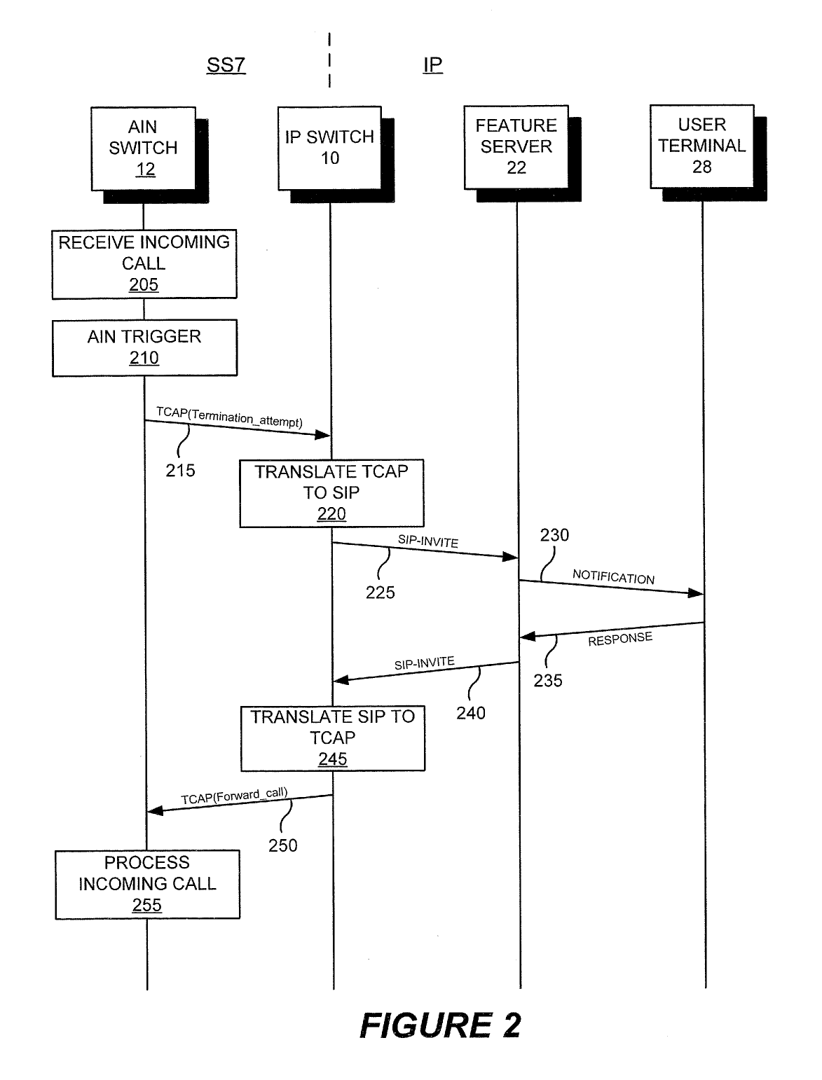

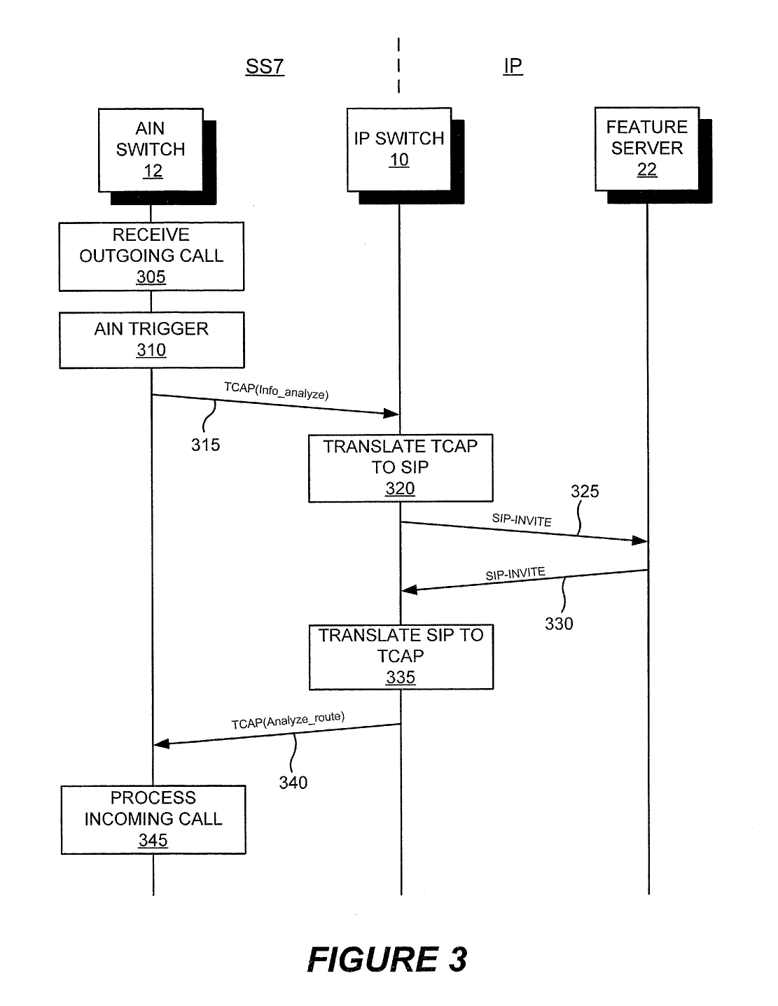

Exemplary message flows illustrating some embodiments of the invention are shown in FIGS. 2 and 3. FIG. 2 is a diagram illustrating message flows that may occur when an incoming call for a subscriber is received at an AIN switch 12. Initially, the AIN switch 12 receives an incoming call to a CPE 16 served by the AIN switch 12 (block 205). If the CPE 16 specified by the incoming call has subscribed to advanced call handling services supported by the Feature Server 22, an AIN trigger occurs (block 210), at which point the AIN switch 12 sends a TCAP message 215 to the IP Switch 10. The TCAP message 215 may be a TCAP(Termination_attempt) message that specifies a Calling_Party_ID and a Called_Party_ID. The Calling_Party_ID may be the telephone number of the calling party, and the Called_Party_ID may be the subscriber's telephone number. For example, where the telephone number of the calling party is (404) 555-1111 and the subscriber's telephone number is (770) 555-2222, the TCAP message may be structured as follows:

```
TCAP (Termination_attempt):
    Calling_Party_ID = 4045551111
    Called_Party_ID = 7705552222
```

Upon receiving this TCAP message, the IP Switch 10 translates the TCAP message to a SIP message (block 220) and sends the translated SIP message 225 to the Feature Server 22. In particular, the translated SIP message may be a SIP-INVITE message structured as follows:

```
SIP-INVITE
    From : 4045551111@von.bellsouth.net
    To: 7705552222@von.bellsouth.net
```

The Feature Server 22 receives the SIP message 225 and determines the identity of the subscriber to which the SIP message 225 relates. The Feature Server 22 then examines the subscriber's profile and determines the appropriate call handling for the call. For example, the Feature Server may determine that the call should be transferred to voicemail, that a specified outgoing message should be played to the caller, that the call should be forwarded to a specified number, that the call should be cleared, or some other disposition.

If the Feature Server 22 determines that the call should be terminated at the CPE 16 (i.e., no call forwarding is to be performed), the Feature Server 22 may return a SIP message 240 to the IP switch 10 with the subscriber's number in the “To” field as follows:

```
SIP-INVITE
    From: 4045551111@von.bellsouth.net
    To: 7705552222@von.bellsouth.net
```

The translated TCAP message 250 from the IP switch 10 to the AIN switch may then be:

```
TCAP(Authorize_termination)
    Calling_Party_ID = 4045551111 (same as original calling number)
    Called_Party_ID = 7705552222
```

If the call is rejected by the Feature Server 22 (as indicated by the Feature Server 22 returning an unsuccessful response to the first SIP-INVITE message 225 from the IP switch 10), the translated TCAP message 250 from the IP switch 10 to the AIN switch 12 may be a TCAP(Disconnect) message.

Upon receipt of the SIP-INVITE message 225, the Feature Server 22 may optionally check the current presence of a subscriber IP terminal 28 associated with the subscriber telephone number and, if the user terminal presence indicates that the user is available at the subscriber IP terminal 28, send a notification message 230 to the subscriber IP terminal 28. For example, the Feature Server 22 may send an instant message notification 230 to the subscriber IP terminal 28 requesting call handling instructions for the call currently being received at the CPE 16. In some embodiments, the message sent by the Feature Server 22 may specify a default call disposition to be used if the user does not respond to the request using the user IP terminal 28. Thus, the Feature Server 22 will specify call handling procedures according to the default call disposition absent contrary instructions received from the user IP terminal 28 in a response 235.

In the illustrated embodiment, the Feature Server 22 determines (either on its own or based on the response 235 from the user IP terminal 28) that the incoming call should be forwarded to a forwarding number, for example, 805-555-3333 in this example. The forwarding number may be associated with another analog telephone, a mobile telephone, a voicemail mailbox, a media server, and/or another type of device. Accordingly, the Feature Server 22 sends a SIP message 240 back to the IP Switch 10. The SIP message 240 may be a SIP-INVITE message structured as follows:

```
SIP-INVITE
    From: 4045551111@von.bellsouth.net
    To: 8055553333@von.bellsouth.net
```

When the IP switch 10 receives the SIP message 240 from the Feature Server 22, the IP Switch 10 recognizes that the message 240 is the response to the earlier SIP-INVITE message 225 transmitted from the IP switch 10 to the Feature Server 22. The receipt of a SIP-INVITE message 240 at the IP switch 10 in response to an earlier SIP-INVITE message 225 may differ from normal SIP message handling on typical VoIP applications. In a conventional VoIP call scenario, the second SIP-INVITE 240 may be sent to an end point in the IP network that is responsible for the called party. However, according to some embodiments of the invention, the IP switch 10 receives the second SIP-INVITE 240 and maps it to an AIN-TCAP message 250 to be returned to the AIN switch 12.

The Feature Server 22 may be configured as a SIP back-to-back user agent. That is, to the outside, the Feature Server 22 may be configured to receive all SIP requests associated with the user, and to the user terminal 28, the Feature Server 22 is the only point of contact for call processing. One benefit of this configuration is that the Feature Server 22 resides between the two call legs (calling party to the Feature Server 22 and the Feature Server 22 to the user) and may be able to handle complex call features easily. For example, if there is an incoming call to the user when the user has already answered a call, the Feature Server 22 can control the three call legs based on user instructions. For example, the user could instruct the Feature Server 22 (via a selection and/or a user profile setting) to put the first call on hold and to answer the incoming call.

Continuing with the exemplary embodiment, in response to the SIP-INVITE message 240 from the Feature Server 22, the IP switch 10 constructs a TCAP response 250 by translating the SIP message to a TCAP(Forward_call) message (block 245) as follows:

```
TCAP (Forward_Call)
    Calling_Party_ID = 4045551111 (same as original calling number)
    Called_Party_ID = 8055553333
```

The IP switch 10 sends the TCAP message 250 to the AIN switch 12. The AIN switch 12 receives the TCAP message 250 and, in response, processes the incoming call according to the call handling procedures specified in the TCAP message 250. In this case, the incoming call is forwarded by the AIN switch 12 to the telephone number specified in the Called_Party_ID field of the TCAP(Forward_Call) message.

The IP Switch 10 will monitor the state of the call and handle the SIP messages transactions properly according to the states of the call. For example—when the call is over, the IP Switch 10 will send a SIP-BYE message to the Feature Server to close the transaction associated with the current call.

The processing of outgoing calls from the CPE 16 according to some embodiments of the invention is illustrated in FIG. 3. As shown therein, when the subscriber completes the dialing of a called telephone number (e.g. 9195554444) (block 305) an AIN trigger occurs if the CPE 16 is subscribed to advanced call handling features (block 310). In response to the AIN trigger, the AIN switch 12 sends a TCAP message 315 to the IP Switch 10. In particular, the AIN switch 12 may send a TCAP (Info_Analyze) message as follows:

```
TCAP (Info_Analyze)
    Calling_Party_ID = 7705556666 (subscriber's number)
    Called_Party_ID = 9195554444
```

Upon receiving this TCAP message, the IP Switch 10 translates the TCAP message to a SIP message (block 320) and sends the translated SIP message 325 to the Feature Server 22. In particular, the translated SIP message may be a SIP-INVITE message structured as follows:

```
SIP-INVITE
    From : 7705556666@von.bellsouth.net
    To: 9195554444@von.bellsouth.net
```

The Feature Server 22 receives the SIP message 325 and determines the identity of the subscriber to which the SIP message 325 relates. The Feature Server 22 then examines the subscriber's profile and determines the appropriate call handling for the call. For example, the subscriber profile of the subscriber to which the SIP message 325 relates may indicate that certain numbers are blocked and/or that calls to certain telephone numbers may be restricted to certain hours. If the called number indicates that a call to a blocked number is being placed, the Feature Server 22 may direct the call to be terminated.

The Feature Server 22 then prepares an SIP message 330, such as an SIP-INVITE message, containing call handling instructions for the identified call and forwards the SIP message 330 to the IP Switch 10.

The IP Switch 10 then translates the SIP message 330 to a TCAP message 340 and returns the TCAP message 340 to AIN switch 12. The AIN switch 12 may then continue the call setup to the destination number (9195554444). For example, the TCAP message 340 may be a TCAP (Analyze-Route) message having the following structure:

```
TCAP (Analyze_Route)
    Calling_Party_ID = 7705556666 (subscriber's number)
    Called_Party_ID = 9195554444
```

That is, if the same numbers are returned to the AIN switch 12 in the TCAP message 340, the AIN switch 12 continues processing of the call. Otherwise, the call may be handled differently by the AIN switch 12. For example, the call may be terminated by the AIN switch 12.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of obtaining call processing instructions for a call to or from an analog telephone in a switched telephone network, the method comprising:
receiving a notification of the call at a service switching point that serves the analog telephone;
sending a call processing instruction request to a network element in the switched telephone network that is also coupled to a data communication network, the call processing instruction request including at least an identity of the calling party and an identity of the called party;
translating the call processing instruction request to a translated request having a format suitable for transmission over the data communication network;
sending the translated request to a feature server over the data communication network;
analyzing the translated request at the feature server to determine a call processing disposition for the call; and
sending a response from the feature server to the network element over the data communication network identifying the determined call processing disposition for the call.

2. The method of claim 1, further comprising:
translating the response from the feature server into a translated response suitable for sending on a switching control network in the switched telephone network;
sending the translated response to the service switching point; and
processing the call at the service switching point in response to the translated response.

3. The method of claim 2, wherein the switching control network comprises an SS7 switching network, wherein the service switching point comprises an advanced intelligent network (AIN) switch that is configured to send and receive Transaction Capabilities Access Part (TCAP) messages, and wherein the call processing instruction request comprises a TCAP message.

4. The method of claim 3, wherein the data communications network comprises an IP network, and wherein translating the call processing instruction request comprises translating the call processing instruction request from a TCAP message to a session initiation protocol (SIP) message.

5. The method of claim 4, wherein the translated request comprises a SIP-INVITE message and wherein the response from the feature server comprises a SIP-INVITE message.

6. The method of claim 3, wherein the call processing instruction request comprises a TCAP(Termination_attempt) message or a TCAP(Info_analyze) message, and wherein the translated response sent to the service switching point comprises a TCAP(Forward_call), a TCAP(Authorize_termination), a TCAP(Disconnect), or a TCAP(Analyze_route) message.

7. The method of claim 6, further comprising:
activating an AIN trigger in response to receiving the notification of the call at the service switching point, the AIN trigger indicating that an alternate call processing routine is to be followed for the call.

8. The method of claim 1, further comprising:
receiving the translated request at the feature server over the data communication network;
analyzing the translated request to determine an identity of a subscriber associated with the call identified in the translated request; and
retrieving a profile associated with the subscriber from a profile database.

9. The method of claim 8, further comprising:
sending a notification message over the data communication network to a subscriber terminal associated with the determined subscriber identity, the notification message requesting instructions for processing the call identified in the translated request.

10. The method of claim 9, further comprising:
receiving a response to the notification message from the subscriber terminal over the data communication network; and
preparing the response from the feature server based on the response from the subscriber terminal.

11. A method of obtaining call processing instructions for a call to or from an analog telephone in a switched telephone network, the method comprising:
receiving a notification of the call at a service switching point that serves the analog telephone;
sending a call processing instruction request to a network element in the switched telephone network that is also coupled to a data communication network, the call processing instruction request including at least an identity of the calling party and an identity of the called party;
analyzing the call processing instruction request to determine an identity of a subscriber associated with the call identified in the translated message;
retrieving a profile associated with the subscriber from a profile database; and
sending a notification message over the data communication network to a subscriber terminal associated with the determined subscriber identity, the notification message requesting instructions for processing the call identified in the call processing instruction request.

12. The method of claim 11, further comprising:
receiving a response to the notification message from the subscriber terminal over the data communication network; and
preparing a response to the call processing instruction request based on the response from the subscriber terminal.

13. The method of claim 12, further comprising:
sending the response to the call processing instruction request to the service switching point over a switching control network in the switched telephone network; and
processing the call at the service switching point based on the response.

14. The method of claim 13, wherein the switching control network comprises an SS7 switching network, wherein the service switching point comprises an advanced intelligent network (AIN) switch that is configured to send and receive Transaction Capabilities Access Part (TCAP) messages, and wherein the call processing instruction request and the response to the call processing instruction request comprise TCAP messages.

15. A communication system, comprising:
a service switching point that serves an analog telephone in a switched telephone network and that is configured to receive a notification of an incoming or outgoing call for the analog telephone and to send a call processing instruction request identifying including at least an identity of the calling party and an identity of the called party in response to the incoming or outgoing call notification;
an IP switch that is coupled to the switched telephone network and that is configured to receive the call processing instruction request and to translate the call processing instruction request to provide a translated request; and
a feature server that is connected to a data communication network and that is configured to receive the translated request from the IP switch, to analyze the translated request to determine a call processing disposition for the call according to a user profile that is configurable by a user of the analog telephone via the data communication network, and to send a response to the IP switch identifying the determined call processing disposition for the call.

16. The communication system of claim 15, wherein the IP switch is further configured to translate the response received from the feature server into a translated response suitable for sending on a switching control network in the switched telephone network, and to send the translated response to the service switching point; and
wherein the service switching point is configured to process the call based on the translated response.

17. The communication system of claim 16, wherein the switching control network comprises an SS7 switching network, and wherein the call processing instruction request comprises a Transaction Capabilities Access Part (TCAP) message.

18. The communication system of claim 17, wherein the data communication network comprises an IP network, and wherein the IP switch is configured to translate the call processing instruction request from a TCAP message to a SIP message and to send the translated request to the feature server via the data communication network.

19. The communication system of claim 15, wherein the feature server is further configured to analyze the translated message to determine an identity of a subscriber associated with the call identified in the translated message, and to retrieve a profile associated with the subscriber from a profile database, to send a notification message over the data communication network to a subscriber terminal associated with the determined subscriber identity, the notification message requesting instructions for processing the call identified in the call processing instruction request, to receive a response to the notification message from the subscriber terminal over the data communication network, and to prepare the response to the call processing instruction request based on the response from the subscriber terminal.

20. The communication system of claim 15, wherein the feature server comprises a feature server module in the IP switch.
